(19) United States
(12) Patent Application Publication
(10) Pub. No.: US 2026/0172650 A1
(43) Pub. Date: Jun. 18, 2026

(54) Edge Relay for Watermarking

(71) Applicant: Synamedia Limited, Maidenhead (GB)

(72) Inventors: Gwenaël Jacques Doërr, Rennes (FR); Gwendal Brieuc Christian Simon, Rennes (FR)

(21) Appl. No.: 18/983,962

(22) Filed: Dec. 17, 2024

(51) Int. Cl. H04N 21/8358

(52) U.S. Cl. CPC H04N 21/8358

(57) ABSTRACT

Techniques for watermarking at the edge in a low latency content delivery system are described herein. In various embodiments, an edge relay server, which includes one or more processors and non-transitory memory, announces a watermarked video track for a media stream. The edge relay server obtains from a client device a watermark identifier associated with a request for the watermarked video track. The edge relay server, in response to receiving the request, subscribes to one or more video tracks in order to receive units in the one or more video tracks representing the media stream. The edge relay server further constructs the watermarked video track using the units according to the watermark identifier and sends to the client device the watermarked video track.

### TECHNICAL FIELD

The present disclosure relates generally to watermarking and, more specifically, to server-side watermarking in low latency media streaming.

### BACKGROUND

Some low latency media streaming systems use relays as intermediary entities to forward media data between publishers (e.g., content sources) and subscribers (e.g., clients). The primary role of a relay is to help distribute media more efficiently by caching and retransmitting data from multiple publishers to multiple subscribers. A relay cannot read or alter the content it forwards. The content is encrypted end-to-end, meaning the relay can handle the data (e.g., for caching or forwarding) but cannot decrypt or understand the actual media content. This ensures privacy and security, preventing relays from tampering with or accessing sensitive media information. However, such properties are incompatible with the requirements for server-side forensic watermarking. Forensic watermarking, by its nature, requires modifying the content on its way to the client. For A/B watermarking, this could involve modifying a catalog that advertises both the A and B variants or reading metadata conveyed in a timeline track, e.g. something similar to Dynamic Adaptive Streaming over HTTP Industry Forum (DASH-IF) WMPaceInfo, to perform A/B sequencing. For edge watermarking, by definition, the delivered video content needs to be altered before it reaches the client. As such, not much progress has been made in existing low latency media streaming systems to accommodate server-side forensic watermarking.

### BRIEF DESCRIPTION OF THE DRAWINGS

So that the present disclosure can be understood by those of ordinary skill in the art, a more detailed description may be had by reference to aspects of some illustrative embodiments, some of which are shown in the accompanying drawings.

FIG. 1 is a block diagram illustrating an exemplary low latency media streaming system with edge relay watermarking, in accordance with some embodiments;

FIG. 2 is a diagram illustrating various units within a low latency media stream and watermark metadata corresponding to various granularities of the units, in accordance with some embodiments;

FIG. 3 is a block diagram illustrating an exemplary edge relay for publishing video tracks and conveying watermark metadata out-of-band in edge watermarking, in accordance with some embodiments;

FIG. 4A is a block diagram illustrating the exemplary edge relay for conveying a video track and in-band watermark metadata in edge watermarking, in accordance with some embodiments;

FIG. 4B is a block diagram illustrating the exemplary edge relay for conveying a video track and out-of-band watermark metadata in edge watermarking, in accordance with some embodiments;

FIG. 5 is a block diagram illustrating the exemplary edge relay for publishing variants of a video track and conveying watermark metadata out-of-band in A/B watermarking in accordance with some embodiments;

FIG. 6A is a block diagram illustrating the exemplary edge relay for constructing a watermark embedded track using in-band watermark metadata in A/B watermarking, in accordance with some embodiments; and

FIG. 6B is a block diagram illustrating the exemplary edge relay for constructing a watermark embedded track using out-of-band watermark metadata in A/B watermarking, in accordance with some embodiments;

FIG. 7 is a flowchart illustrating a method of edge relay watermarking, in accordance with some embodiments; and

FIG. 8 is a block diagram of a computing device for edge relay watermarking, in accordance with some embodiments.

In accordance with common practice the various features illustrated in the drawings may not be drawn to scale. Accordingly, the dimensions of the various features may be arbitrarily expanded or reduced for clarity. In addition, some of the drawings may not depict all of the components of a given system, method, or device. Finally, like reference numerals may be used to denote like features throughout the specification and figures.

### DESCRIPTION OF EXAMPLE EMBODIMENTS

Numerous details are described in order to provide a thorough understanding of the example embodiments shown in the drawings. However, the drawings merely show some example aspects of the present disclosure and are therefore not to be considered limiting. Those of ordinary skill in the art will appreciate that other effective aspects and/or variants do not include all of the specific details described herein. Moreover, well-known systems, methods, components, devices, and circuits have not been described in exhaustive detail so as not to obscure more pertinent aspects of the example embodiments described herein.

### Overview

Methods, devices, and systems described herein introduce an edge relay server to overcome the limitations of relays that cannot read or alter content in low latency media streaming protocols. To enable edge relay watermarking, in some embodiments, an edge server (also known as an edge relay server or an edge relay) obtains a watermark identifier from the client, e.g., the client providing the watermark identifier (WMID) as a parameter when subscribing to a video track or as an upstream Media over QUIC (MoQ) track to the edge server. The edge server then subscribes to the selected tracks from the headend publisher, constructs tracks to be delivered to the client, and publishes those tracks to the clients. To enable watermark embedding, in some embodiments, timeline tracks are leveraged to convey synchronized metadata off-band, such as Dynamic Adaptive Streaming over HTTP Industry Forum (DASH-IF) WMPaceInfo for A/B watermarking or embedding instructions for watermarking at the edge server. At the end of the watermark embedding process, in some embodiments, the edge server also modifies the catalog track in the edge server to stop the transmission of timeline metadata tracks and/or to cease advertising the A/B variants to the client.

In accordance with various embodiments, an edge relay watermarking method is performed at a server that includes one or more processors and non-transitory memory. The method includes announcing a watermarked video track for a media stream. The method further includes obtaining from a client device a watermark identifier associated with a request for the watermarked video track. The method also includes in response to receiving the request, subscribing to one or more video tracks in order to receive units in the one or more video tracks representing the media stream. The method additionally includes constructing the watermarked video track using the units according to the watermark identifier, and sending to the client device the watermarked video track.

### Example Embodiments

Live video streaming is a service where the glass-to-glass latency (from the camera capturing the event to the display of the consumer) is minimized while still maintaining a reasonably good video quality. The ultra-low-latency term coins any streaming system where the glass-to-glass latency is around 1 second or lower. With this target, the streaming protocols based on publish/subscribe (pub/sub), where the video is constantly pushed from the publisher to the subscriber, have become dominant.

In pub/sub architectures, a server publishes new content and serves it to anyone who has subscribed to this content. Such approaches have been used to stream video content over the Internet since the 1990s, for instance with protocols such as RTP and WebRTC. It has however been superseded in recent years by HTTP-based ABR systems where each end-user requests successive video segments iteratively using protocols such as DASH and HLS. The limitations of HTTP ABR streaming have led the community to start a new project, namely Media over QUIC (MoQ), to design a new streaming protocol based on pub/sub.

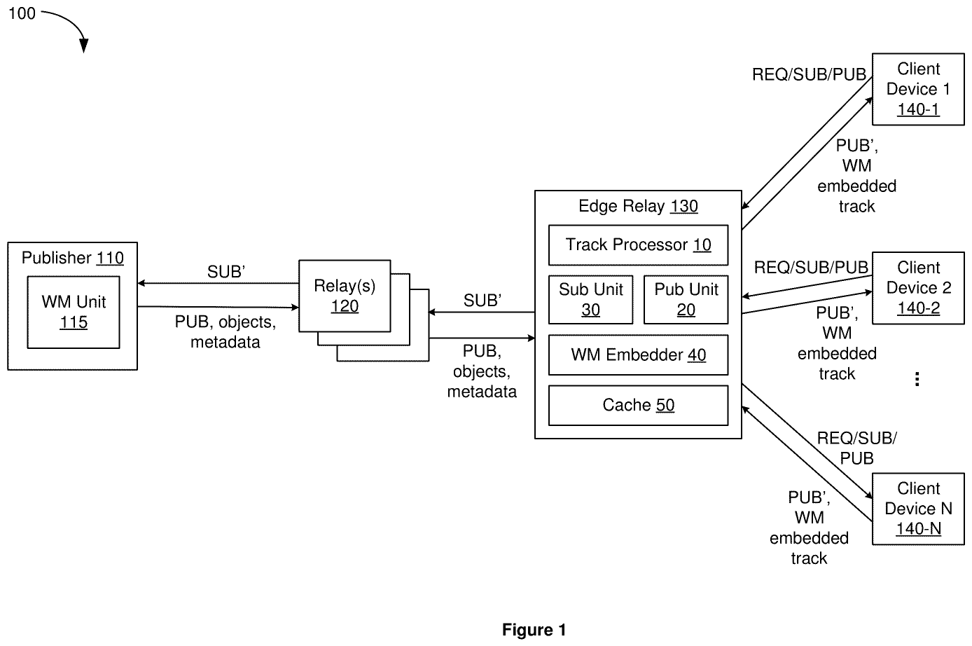

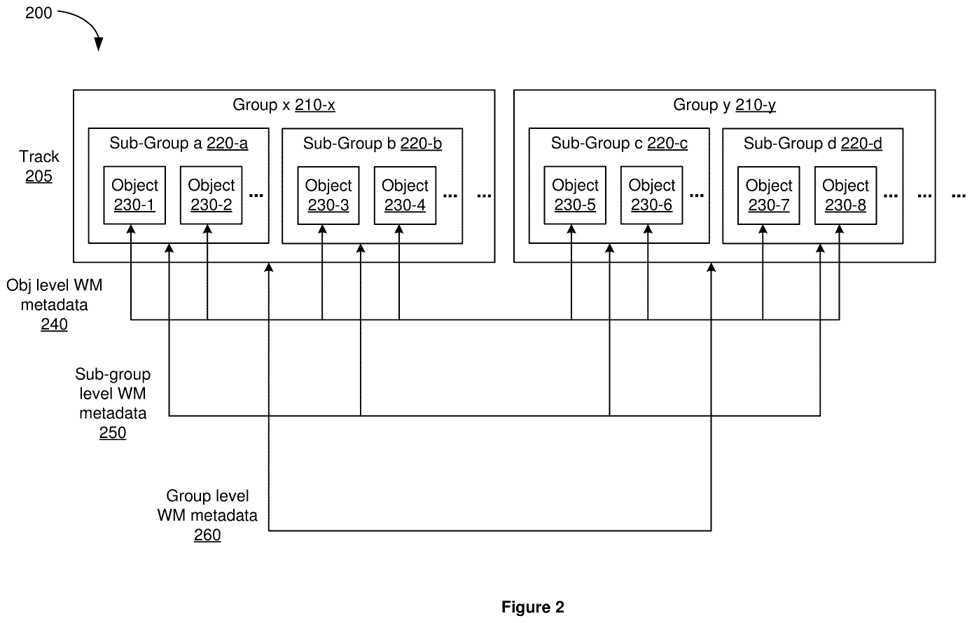

FIG. 1 is an exemplary MoQ content delivery system 100 with edge relay watermarking in accordance with various embodiments. In some embodiments, the exemplary content delivery system 100 includes a publisher 110 (also referred to as a headend 110 or a headend publisher 110) for publishing content and a plurality of client devices 140 (e.g., client device 1 140-1, client device 2 140-2, . . . , client device N 140-N, etc.) for receiving content. The content packaged and delivered according to MoQ protocol includes units at various granularities. For example, FIG. 2 is a diagram 200 illustrating various units within a content stream. In MoQ, a track 205 is a temporal sequence of groups representing continuous media streams, such as different video qualities or audio channels. A MoQ server (e.g., the publisher 110 or a respective relay 120 in FIG. 1) transmits the track 205 over QUIC protocol, utilizing its multiplexing capabilities to send multiple streams simultaneously. Within the track 205, objects 230 (e.g., objects 230-1 through 230-8) are discrete units of media data like video segments or audio chunks. Each of the objects 230 is a basic data element and addressable unit. Sub-groups 220 (e.g., sub-group a 220-a, sub-group b 220-b, sub-group c 220-c, and sub-group d 220-d, etc.) are collections of the objects 230 to transmit in a single QUIC stream. Groups 210 (e.g., group x 210-x and group y 210-y, etc.) are collections of related objects 230. Each of the groups 210 is a temporal sequence of the objects 230 and a joint point for subscriptions, ensuring that media components, such as all parts of a video frame, are processed together.

Referring back to FIG. 1, at the receiving end of the content delivery system 100, a subscriber (either an end-user at a respective client device 140 or a respective relay 120) requests specific media tracks and adapts track selection according to network conditions. The MoQ protocol defines two types of subscription: a Subscribe message (SUB) allows a subscriber to notify a server about its interest in receiving the live flow of media data related to a track, while a Fetch is related to past data of the track. In both cases, the server (either the publisher 110 or a respective relay 120) sends the respective flow of data to the subscriber (either another relay 120 or the end-user at the respective client device 140) as soon as the data (e.g., a new object, a new sub-group, and/or a new group) is available. In some embodiments, the publisher 110 includes a watermark unit 115 for facilitating server-side watermarking.

To assist the subscribers, in some embodiments, the publisher 110 declares the track it can output by sending Announce messages, which detail the characteristics of the track. In some other embodiments, the publisher 110 issues a Catalog, which is a metadata structure that lists all the available media tracks, objects, sub-groups, and groups that a subscriber can request. The Catalog serves as an index or directory, detailing the different versions, qualities, and types of media available for streaming. Another metadata structure that the publisher may emit is the Timeline, which provides details about past objects and groups of the tracks.

In the exemplary content delivery system 100, one or more relays 120 (also referred to as MoQ relay(s) 120) refer to one or more servers within the MoQ protocol that act as intermediary point(s), receive media streams from the publisher 110 and forward them to subscribers, effectively allowing for efficient distribution of media across the network shown in FIG. 1. The relay(s) 120 are particularly useful when dealing with large audiences or geographically dispersed client devices 140 for real-time media streams.

On the one hand, the MoQ relay 120 acts as an intermediary entity, which forwards media data between the publisher 110 (e.g., content sources) and the subscribers (e.g., clients at the client devices 140). Because the primary role of the relays 120 is to help distribute media more efficiently by caching and retransmitting data from the publisher 110 (and potentially multiple publishers) to multiple subscribers, the relays 120 cannot read or alter the content they forward. The content is encrypted end-to-end, meaning the relays 120 can handle the data (e.g., for caching or forwarding) but cannot decrypt or understand the actual media content. This ensures privacy and security, preventing relays from tampering with or accessing sensitive media information.

On the other hand, forensic watermarking by essence requires modifying the content on its way to the client. Forensic watermarking is a technique used to embed unique, invisible marks within digital content to track its usage and distribution. It is routinely used for video entertainment content delivery to combat piracy. When content owners discover their content illegally redistributed on some pirate platform, they can lift the underlying forensic watermark to identify the device or user to whom this unique version of the content has been delivered. They can then take remedial action e.g. by terminating the access privilege of this user. The rapid development of consumer-owned mobile devices has prompted watermarked vendors to gradually shift from client-based solutions to server-side solutions. With the latter ones, the client provides an identifier when requesting content from the delivery network and a watermark engine present in the delivery network ensures that the client receives a unique copy of the content based on the provided identifier. As will be described in further detail below, there are different types of server-side watermarking techniques. However, there is fundamental incompatibility between the properties of a MoQ relay and the requirements for server-side forensic watermarking.

To enable edge watermarking, the exemplary content delivery system 100 includes a MoQ edge relay 130 (also referred to as an edge relay 130 or an edge server 130). In essence, the edge relay 130 is a server placed at the edge of the MoQ video network, which subscribes to the MoQ tracks of the headend publisher 110 and publishes MoQ tracks to the subscriber. In some embodiments, the edge relay 130 includes a watermark embedder 40 for obtaining a watermark identifier from the client devices 140 and performing watermark embedding. In some embodiments, the edge relay 130 includes a subscription unit 30 for subscribing to selected tracks from the headend publisher 110 (possibly through several relays 120) and or the client device 140, a track processor 10 for processing metadata and constructing tracks to be delivered to the client devices 140, and a publishing unit 20 for publishing those tracks to the client devices 140, e.g., via messages carrying MoQ objects (referred to hereinafter as PUB messages). In some embodiments, the edge relay 130 also includes a cache 50 for caching requests, metadata, and/or portions of media content items for improved efficiency and reduction of bandwidth usage and latency. For example, if there are 10 users watching the same stream, the edge relay 130 subscribes once to the publisher 110 upon receiving a request for the stream from one of the client devices 140 for the first time and caches the request, the watermark metadata, and/or the media content. Upon receiving subsequent requests from other client devices 140 for the same stream, the edge relay 130 forgoes subscribing to the same stream.

The watermarking process starts when a respective client device 140 sends a request to the edge relay 130 for a watermarked video track. In some embodiments, the request is a SUB message and the watermark identifier (WMID) is included in the SUB message, e.g., providing the WMID as the auth parameter in the SUB message. Alternatively, in some embodiments, the WMID is provided on its own or incorporated to another object when the client device 140 sends the request, e.g. an access token. In some other embodiments, since in MoQ protocol, any end-point can become a publisher, the client device 140 publishes an authentication MoQ metadata track (also referred to as the authentication track), e.g., sending a PUB message to the edge relay 130. In some embodiments, the authentication track, for each group, sends a new WMID, which the edge relay 130 can detect and interpret. In some embodiments, the subscription unit 30 subscribes to this authentication track to obtain the WMID emitted from the particular client device 140. In some embodiments, when the WMID is updated at regular intervals, because of the subscription, the edge relay 130 periodically receives the updated WMID from the client device 140.

As will be described in further detail below, introducing the edge relay 130 overcomes the limitations of QUIC relays 120 that cannot read or alter content. To enable edge relay watermarking, in some embodiments, the edge relay 130 leverages Timeline tracks in MoQ protocol to convey synchronized watermark metadata off-band such as DASH IF WMPaceInfo for A/B watermarking or embedding instructions for watermarking at the edge. Further, to facilitate edge relay watermarking, in some embodiments, the track processor 10 modifies the Catalog track in MoQ protocol to stop the transmission of Timeline metadata tracks and/or to stop advertising the A/B variants to the client devices 140.

For example, as shown in FIG. 1, upon receiving a PUB message conveying a Catalog track from the publisher 110 via the relay(s) advertising the A/B variants, the track processor 10 coordinates with the publishing unit 20 to construct its own Catalog track and sends a PUB′ message to the client devices 140 to advertise a watermarked video track. Subsequently, upon receiving the SUB message from the client devices 140, the track processor 10 coordinates with the subscription unit 30 to generate and send a SUB′ message upstream to the publisher 110 via the relay(s) 120 to subscribe to the A/B variants and possibly to the associated metadata tracks (e.g., Timeline tracks) provided by the publisher 110. In A/B watermarking, the WMPaceInfo is the same for all watermarked video tracks and the metadata can be consolidated in a single metadata track, such as a single Timeline track or a single Catalog track. In edge watermarking, the watermarking instructions are different for each video track and in some embodiment, each watermarked video track has a corresponding metadata track.

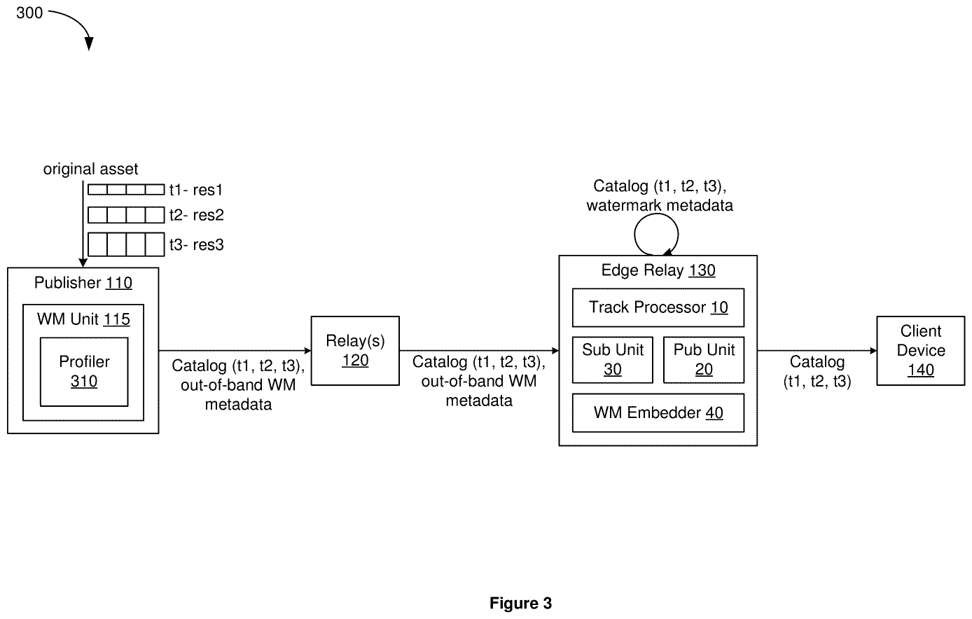

In another example, upon receiving one or more Timeline metadata tracks in a PUB message, instead of relaying the Timeline metadata track(s), the edge relay 130 stops the transmission of Timeline metadata track(s) to the client devices 140, the track processor 10 coordinates with the watermark embedder 40 to record the watermark metadata at the edge relay 130. Subsequently, upon receiving requested objects from the publisher 110 via the relay(s) 120, the watermark embedder 40 applies the watermark metadata for generating the watermark embedded track. Various embodiments of using the edge relay 130 for server-side watermarking are described below with reference to FIGS. 3-6.

FIG. 3 is a block diagram 300 illustrating publishing video tracks and conveying watermark metadata out-of-band in edge watermarking in accordance with some embodiments. One server-side watermarking blueprint, named edge watermarking, aims at mitigating some of the limitations of A/B watermarking, namely: (i) the footprint in cache is doubled to transport the A and B variants at the Content Delivery Network (CDN) edge; and (ii) one cannot embed watermarking information faster than one bit every ABR segment, typically a few seconds. This solution involves a preparation step in the video headend publisher 110 performed by a profiler 310. In some embodiments, the profiler 310 analyzes the video to derive watermark embedding instructions that are forwarded along the video to the CDN as some synchronized metadata. The watermark embedding instructions specify where and how to modify media content to encode watermark information. The bandwidth overhead induced by this additional metadata is usually negligible. By performing primary computations on the server side and sending metadata as watermarking instructions over the network, edge watermarking improves security and scalability and at the same time, reduces cost and latency. In some embodiments, the publisher 110 makes the announcement of the video tracks, for example by Announce messages or a Catalog message, e.g., Catalog (t1, t2, t3). The relay(s) 120 forwards such announcement as well as track(s) of watermark metadata. In some embodiments, the edge relay 130 makes the same announcements, for example by publishing the same untampered Catalog (t1, t2, t3) as watermark tracks.

In some embodiments, as shown in FIG. 3, the publisher 110 obtains an original asset in multiple tracks, e.g., for different resolutions such as a first track (t1) for a first resolution, a second track (t2) for a second resolution, and a third track (t3) for a third resolution, etc. Further, in some embodiments, embedding instructions as watermark metadata generated by the profiler 310 are provided in individual tracks, either one for all video tracks, e.g., one Timeline track for video tracks t1, t2, and t3, or one Timeline track for each video track, e.g., one Timeline track for video track t1, another Timeline track for video track t2, and yet another Timeline track for video track t3. In such embodiments, the edge relay 130 subscribes to the watermark metadata tracks (also referred to hereinafter as the metadata tracks) to obtain the embedding instructions to be applied to the groups of the video track, e.g., subscribing by the subscription unit 30 to one or more watermark metadata tracks associated with video tracks t1, t2, and t3. In some embodiments, the edge relay 130 (e.g., the track processor 10 and/or the watermark embedder 40) extracts the watermark metadata upon receiving the watermark metadata track(s) and discards such watermark metadata track(s) when making its announcements to the client device 140, by not sending any related Announce message or by omitting such Timeline track(s) into the Catalog message published to the client device 140.

It should be noted that the watermark metadata generated by the profiler 310 can be applied on not only unencrypted content, but also encrypted and encoded content. Accordingly, the watermark embedder 40 on the edge relay 130 can apply watermarks according to the profiling results without decrypting, decoding, re-encoding, and/or re-encrypting at the edge.

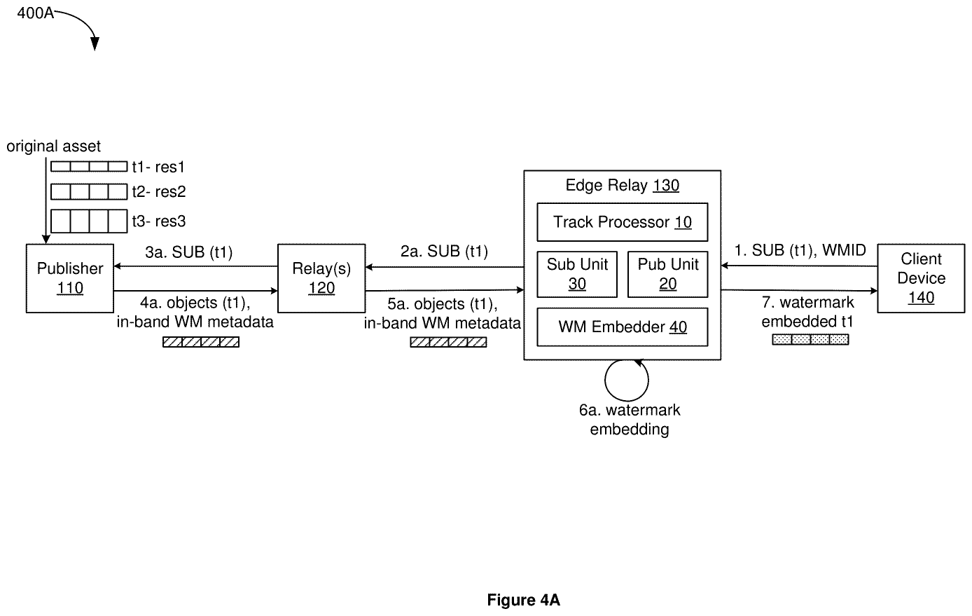

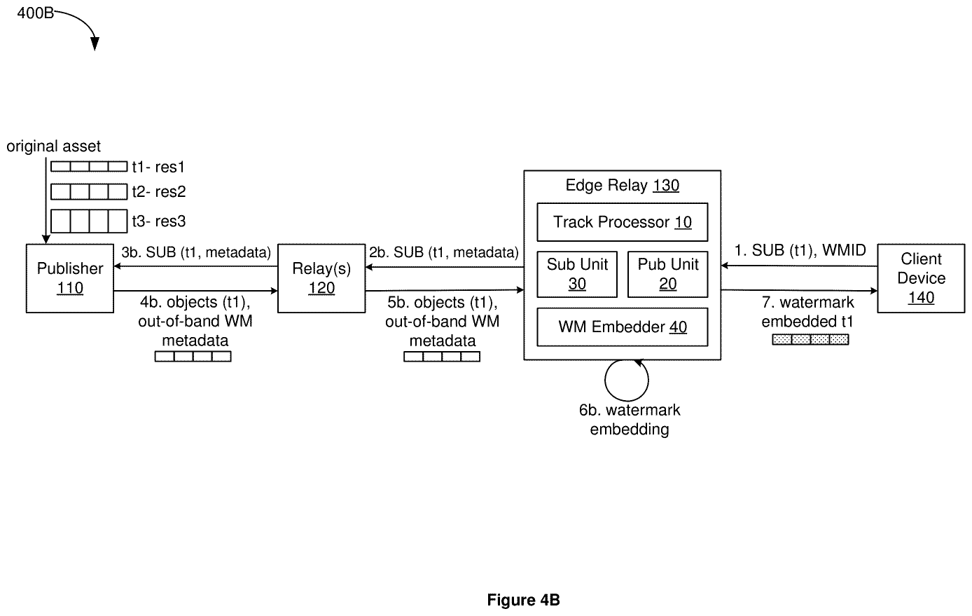

FIG. 4A is a block diagram 400A illustrating conveying a video track and in-band watermark metadata in edge watermarking in accordance with some embodiments. In some embodiments, the client device 140 emits a subscribe message to subscribe to one of the watermark tracks announced through the Catalog message in step 1, e.g., SUB(t1), where the subscribe message includes a WMID associated with the client device 140. In response to receiving the subscribe message, the edge relay 130 generates and sends a subscribe message to the publisher 110 via the relay(s) 120 in steps 2a and 3a, e.g., generating and sending SUB(t1). In some embodiments, in step 4a, the publisher 110 obtains the requested video track and incorporates watermark metadata (e.g., watermark embedding instructions) generated by the profiler 310 in-band within the video track to the client device 140, e.g., in the video track t1. The relay(s) 120 forward the objects in the video track with in-band watermark metadata in step 5a, e.g., including the watermark metadata in the header of the video data. In step 6a, the edge relay 130 (e.g., the watermark embedder 40) applies the watermark instructions it receives in-band from the publisher 110 to the units in the video track and uses the watermark identifier provided by the client device 140 to generate watermark embedded track t1 before serving watermarked units to the client device 140 in step 7.

In some embodiments, the watermark metadata generated by the profiler 310 (FIG. 3) can include a list of (offset, original_value, alternate_value) triplets, where the offset specifies the position within the content, and original_value and alternate_value are values that can be placed interchangeably at the offset without introducing visible artifacts while being detectable. In another example, to specify a rule of performing four changes per WMID bit, the watermark metadata specify applying {(offset_1, original_value), (offset_2, alternate_value), (offset_3, alternate_value), (offset_4, original_value)} to embed a WMID bit that equals to 0 and applying {(offset_1, alternate_value), (offset_2, original_value), (offset_3, original_value), (offset_4, alternate_value)} to embed a WMID bit that equals to 1. In some embodiments, the profiler 310 (FIG. 3) groups several modification tuples and defines antipodal sequences, such as {original_value, alternate_value, alternate_value, original_value} and {alternate_value, original_value, original_value, alternate_value}, that would be applied at locations {offset_1, offset_2, offset_3, offset_4} to encode a watermark bit equal to 0 and 1, respectively.

As shown in FIG. 4A, in edge watermarking, a single version of the video track together with the watermark metadata is transiting through the network from the publisher 110 to the client device 140, thus allowing edge watermarking while preserving the low bandwidth overhead of transmitting the watermark metadata. Further, different from the relay(s) 120 that do not have the capability of modifying the relayed data, the edge relay 130 applies the watermark embedding instructions onto the objects in the video track according to the client watermark identifier before forwarding the result further downstream, thus allowing edge watermarking in a MoQ content delivery system.

FIG. 4B is a block diagram 400B illustrating conveying a video track and out-of-band watermark metadata in edge watermarking in accordance with some embodiments. The system illustrated in FIG. 4B is similar to the system illustrated in FIG. 4A with reference to steps 1 and 7. Accordingly, elements common to FIGS. 4A and 4B include common reference numbers, and only the differences between FIGS. 4A and 4B are described herein for the sake of brevity. As in FIG. 4A, in FIG. 4B, in step 1, the client device 140 emits a subscribe message to subscribe to one of the watermark tracks announced through the Catalog message, e.g., SUB(t1), where the subscribe message includes a WMID associated with the client device 140.

Different from FIG. 4A, in response to receiving the subscribe message, the edge relay 130 generates and sends one or more subscribe messages to the publisher 110 in steps 2b and 3b, where the subscribe message(s) not only subscribe to the video tracks t1, but also subscribe to a dedicated watermark embedding metadata track. In some embodiments, in steps 4b and 5b, the publisher 110 sends the requested video track and the watermark metadata (e.g., watermark embedding instructions generated by the profiler 310) out-of-band to the client device 140. In step 6b, the edge relay 130 (e.g., the watermark embedder 40) applies the watermark instructions it receives from the publisher 110 out-of-band to the units in the video track and uses the watermark identifier provided by the client device 140 to generate watermark embedded track t1 before serving watermarked units to the client device 140 in step 7.

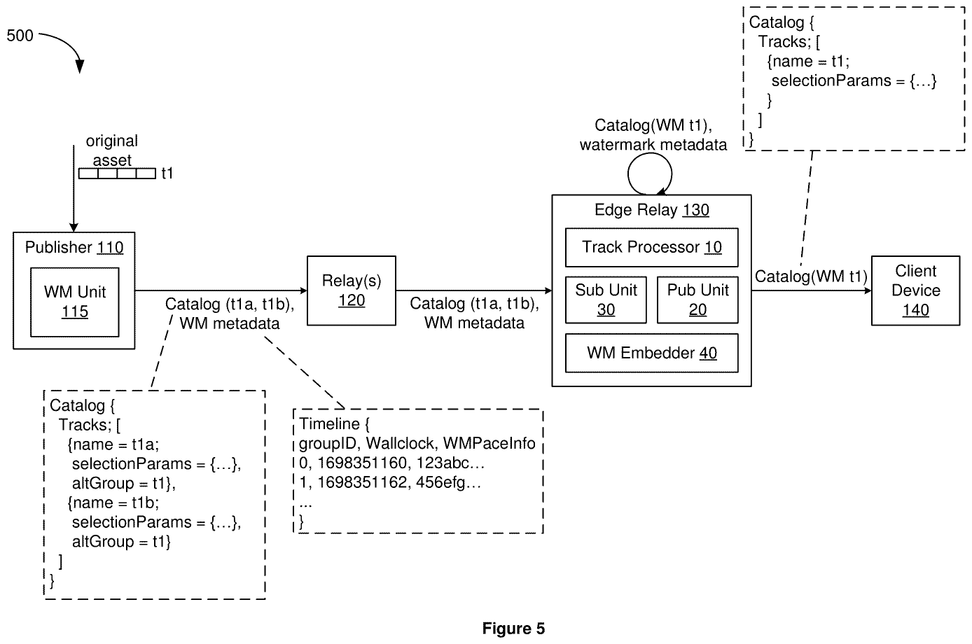

FIG. 5 is a block diagram 500 illustrating publishing variants of a video track and conveying watermark metadata out-of-band in A/B watermarking in accordance with some embodiments. The most well-known server-side watermarking blueprint is A/B watermarking for segmented content, e.g., HTTP Live Streaming (HLS) and/or Dynamic Adaptive Streaming over HTTP (DASH) video. In essence, the video headend service is modified to provide two pre-watermarked A and B variants of each individual adaptive bit rate (ABR) video segment. The behavior of the video delivery network is then altered to ensure that each client receives a unique sequence of A and B ABR segments. While early implementations relied on playlist manipulation, the most up-to-date implementations leverage edge computing capabilities to redirect the client requests to its A or B variant depending on their WMID. Such A/B redirection edge logic typically requires assigning a bit of the watermark identifier to each video segment. The edge then delivers the A or B variant with respect to the value of this bit in the watermark identifier. The traditional implementation of A/B watermarking relies on name convention, where the edge extracts from the segment name the bit of the watermark identifier. Yet, this solution based on naming has some limitations, which has derived into too many proprietary implementations. To favor interoperability across vendors, DASH Industry Forum (DASH-IF) has standardized several interfaces for A/B selection at edge. More specifically, DASH-IF specification defines the format of the watermark token that is used to convey the watermark identifier. Moreover, it introduces an auxiliary metadata stream (e.g., WMPaceInfo), which lets the video headend explicitly signal to the delivery network which bit of the watermark identifier would be considered for A/B sequencing for each individual ABR video segment.

As shown in FIG. 5, the watermark unit 115 in the publisher 110 duplicates a video track t1 into two tracks t1a and t1b, corresponding to the A and B variants. In some embodiments, the publisher 110 declares the two tracks by emitting a Catalog message, which references track t1a for the A variant track and track t1b for the B variant track. In some embodiments, in response to detecting the announcement from the publisher 110 of the Catalog track via the relay(s) 120, the track processor 10 processes the information in the Catalog message, e.g., recording a mapping of the variant tracks t1a and t1b to an A/B neutral track name t1. In some embodiments, the publisher 110 publishes and/or announces t1 and t1b for the variants A and B. As a result, the edge relay 130 can discard some tracks to construct its catalog and does not need to modify the naming of the A track.

Further, through the publishing unit 20, the edge relay 130 announces the A/B neutral track name (e.g., video-bitrate1). For example, in FIG. 5, the edge relay 130 announces the A/B neutral track in a Catalog message, e.g., a Catalog message announcing the name of the tracking being t1. Alternatively, the edge relay 130 announces the A/B neutral track in Announce messages in accordance with some embodiments. In some embodiments, the naming of the tracks is explicit enough to not require the publisher 110 to formally declare all tracks. For example, in the case of video-bitrate1-A and video-birate1-B being the two variant tracks A and B related to the track video-bitrate1, and the publisher 110 declares track video-bitrate1 in the Catalog message.

In some embodiments, the publisher 110 signals which bit of the watermark identifier would be considered for each unit in the track. In some embodiments, the watermark signaling is sent in a Timeline A/B metadata track as shown in FIG. 5. A Timeline track reports data about previous groups and objects. For example, the exemplary Timeline A/B metadata shown in FIG. 5 includes a group ID field, a Wallclock field indicating the time at which the group corresponding to the group ID has been emitted by the publisher 110, and a WMPaceInfo field, which the edge relay 130 can interpret in order to select the A or B variant. It should be noted that FIG. 5 illustrates encrypted information in the WMPaceInfo field, while in various embodiments, the WMPaceInfo can include encrypted or unencrypted watermark embedding instructions.

It should be noted that in comparison to the value position of DASH IF WMPaceInfo, the signal in the Timeline track applies at MoQ group level rather than ABR segment level. It should also be noted that though FIG. 5 illustrates signaling at MoQ group level in accordance with some embodiments, the watermark signal from the publisher 110 can be applied at the object or sub-group granularity rather than a group. For example, as shown in FIG. 2, instead of specifying the WMPaceInfo for each of the groups, entries in the Timeline track can specify object ID or sub-group ID, followed by the timestamp for the respective object or sub-group ID indicating the time at which the corresponding object or sub-group has been emitted by the publisher 110, and then followed by the WMPaceInfo field for each of the corresponding object or sub-group, which includes the watermark embedding instructions for the edge relay 130 to interpret and apply.

Because for A/B watermarking, the metadata WMPaceInfo are the same across variants and representations, the preferred embodiment is a single watermark metadata track for A and B variants of all video tracks. In some embodiments, instead of having one Timeline track for both the A variant track and the B variant track referenced in the Catalog as shown in FIG. 5, the publisher 110 incorporates a Timeline A/B metadata track for each A/B variants video track pairs (e.g., N metadata tracks for N video tracks) or for each video track (e.g., 2N metadata tracks for N video tracks) in the Catalog. In such embodiments, the watermark unit 115 records in the WMPaceInfo field a WMID bit index. For example, the watermark unit 115 can specify in the value variant field of DASH IF WMPaceInfo for a MoQ object, sub-group, or group, thereby lifting naming requirements on group names.

For example, in ABR, there is typically a number in the segment filename such as a counter or timestamp. Based on this number, the WM embedder 40 derives the WMID bit that would be considered for A/B decision making, e.g., WMID_bit_index=counter modulo WMID_length or WMID_bit_index=floor(timestamp/unit_duration) modulo WMID_length. When having WMPaceInfo as a dedicated track, the A/B watermarking can be performed based on the group names or the timestamp of the first frame in a group.

In some embodiments, upon receiving the Timeline track(s), the edge relay 130 interprets the WMPaceInfo information and extracts the watermark embedding instructions for A/B watermarking. Further, regardless of the number of Timeline track(s) the edge relay 130 receives in accordance with various embodiments, the edge relay 130 discards such Timeline A/B metadata track(s) when constructing the Catalog published to the client device 140, e.g., publishing Catalog track announcing t1 without publishing any Timeline track for the track t1 to the client device 140.

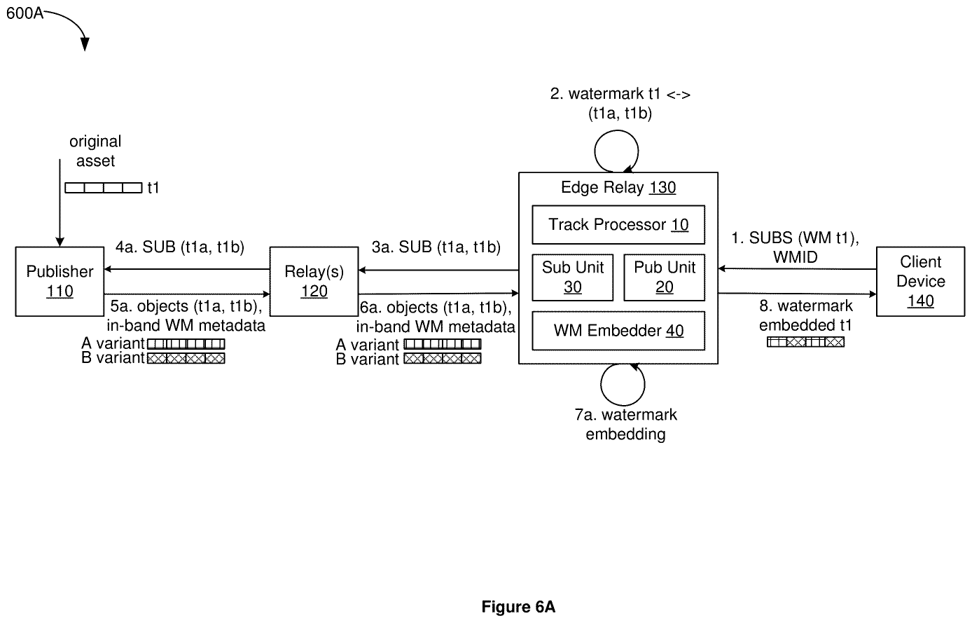

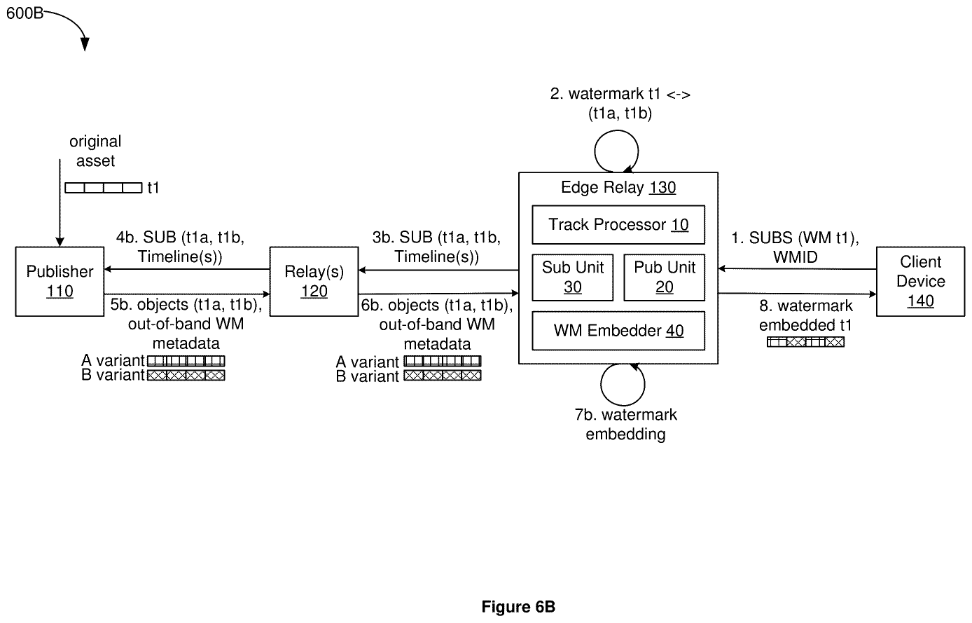

In yet another embodiment, the publisher 110 does not incorporate any Timeline metadata track. In such embodiments, as will be described in further detail below with reference to FIG. 6A, the watermark metadata is transmitted in-band with the video tracks. In such embodiment, the edge relay 130 derives a bit index from metadata attached to the unit, e.g. the unit identifier, a timestamp attached to the unit, etc., and selects which unit in the A variant track or the B variant track would be included to the watermarked video track according to the watermark identifier and the bit index.

FIG. 6A is a block diagram 600A illustrating constructing a watermark embedded track using in-band watermark metadata in A/B watermarking in accordance with some embodiments. In some embodiments, when the edge relay 130 receives a subscription to one of its published video tracks in step 1, e.g., receiving a SUB (t1) message from the client device 140, it determines that the published video track corresponds to A and B variants t1a and t1b in step 2. In steps 3a and 4a, the edge relay 130 subscribes to the corresponding A and B variants to the headend publisher 110 via the relay(s) 120. In steps 5a and 6b, the publisher 110 sends the objects in the A/B variants tracks with the watermark metadata delivered in-band to the edge relay 130. In step 7a, the edge relay 130 derives a bit index from metadata attached to the unit in-band, e.g. the unit identifier, a timestamp attached to the unit, etc., and selects which unit in the A variant track or the B variant track would be included to the watermarked video track according to the watermark identifier and the bit index. For example, when the edge relay 130 obtains objects in a group with a corresponding group ID, the edge relay 130 applies a function such as the group ID mod 32 to derive the bit index of a 32-bit WMID of the subscriber. Based on the bit index and the WMID of the client device 140, the watermark embedder 40 selects a unit from either the A variant or the B variant and includes the selected unit to the watermarked video track constructed by the edge relay 130. The edge relay 130 then serves a unique sequence of A and B groups to the client device 140 with watermark embedded in step 8.

FIG. 6B is a block diagram 600B illustrating constructing a watermark embedded track using out-of-band watermark metadata in A/B watermarking in accordance with some embodiments. The system illustrated in FIG. 6B is similar to the system illustrated in FIG. 6A with reference to steps 1-2 and 8. Accordingly, elements common to FIGS. 6A and 6B include common reference numbers, and only the differences between FIGS. 6A and 6B are described herein for the sake of brevity. As in FIG. 6A, in FIG. 6B, when the edge relay 130 receives a subscription to one of its published video tracks in step 1, e.g., receiving a SUB (t1) message from the client device 140, it determines that the published video track corresponds to A and B variants t1a and t1b in step 2.

Different from FIG. 6A, in steps 3b and 4b of FIG. 6B, the edge relay 130 subscribes to the corresponding A and B variants to the headend publisher 110 via the relay(s) 120 as well as subscribes to watermark metadata track(s) associated with the video tracks, e.g., subscribing to the Timeline track(s) shown in FIG. 5. Also different from steps 5a and 6b in system 600A, in steps 5b and 6b, the publisher 110 sends the objects in the A/B variants tracks with the watermark metadata delivered out-of-band to the edge relay 130. In step 7b, the watermark embedder 40 derives a bit index from out-of-band watermark metadata. For example, the watermark embedder 40 in step 7b can obtain a bit index for each unit of the A and B variants from the Timeline track(s), select a unit from either the A variant or the B variant and include the selected unit to the watermarked video track t1 according to the WMID received in step 1 and the bit index. The edge relay 130 then serves a unique sequence of A and B groups to the client device 140 with watermark embedded in step 8.

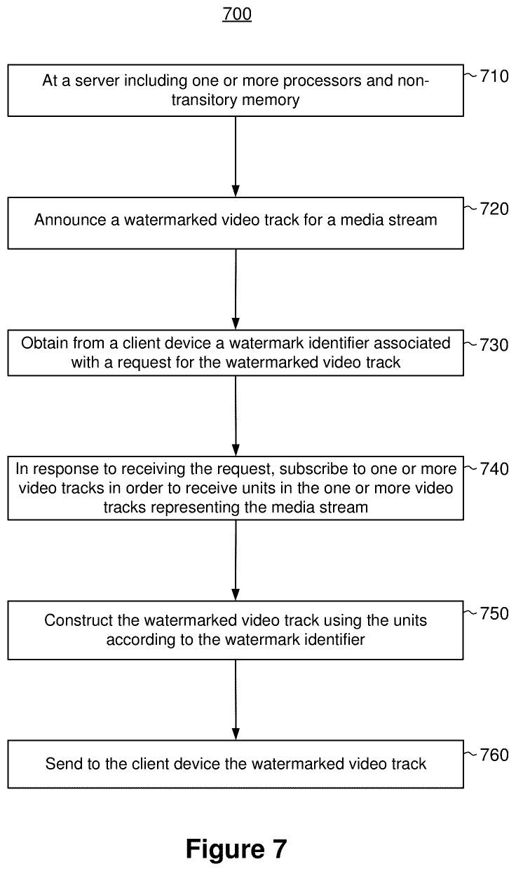

FIG. 7 is a flowchart illustrating a method 700 for edge relay watermarking in accordance with some embodiments. In some embodiments, as represented by block 710, the method 700 is performed at a server that include one or more processors and non-transitory memory, e.g., a server hosting the edge relay 130 (FIG. 1). As represented by block 720, the method 700 includes announcing a watermarked video track for a media stream. For example, in FIG. 3, for edge watermarking, the edge relay 130 announces multiple watermarked video tracks t1, t2, and t3 emitting a message Catalog(t1, t2, t3), where the watermarked video tracks t1, t2, and t3 correspond to various resolutions of a media stream received by the publisher 110. In another example, in FIG. 5, for A/B watermarking, the edge relay 130 announces a watermarked video track t1 by emitting a message Catalog(t1), where the watermarked video track t1 corresponds to the original media stream t1 received by the publisher 110.

In some embodiments, announcing the watermarked video track for the media stream includes, detecting announcement of a metadata track associated with the one or more video tracks, and announcing the watermarked video track without announcing the metadata track. For example, in FIG. 3, regardless of the number of Timeline track(s) the edge relay 130 receives in accordance with various embodiments, the edge relay 130 discards such Timeline watermark metadata track(s) when constructing the Catalog published to the client device 140, e.g., publishing Catalog track announcing (t1, t2, and t3) without publishing any Timeline track(s) to the client device 140.

The method 700 further includes obtaining from a client device a watermark identifier associated with a request for the watermarked video track, as represented by block 730. In some embodiments, the request is a subscribe message from the client device to the server and the watermark identifier is included in the subscribe message. For example, as shown in FIGS. 4 and 6, the edge relay 130 receives the SUB message from the client device 140 as the request and in some embodiments, the WMID is included in the track subscription request of the client, e.g., using the auth parameter in the SUB message. In some embodiments, obtaining from the client device the watermark identifier includes detecting an authentication track (e.g., an authentication MoQ metadata track) published by the client device as the request, and obtaining the watermark identifier by subscribing to the authentication track. For example, instead of sending a SUB message as shown in FIGS. 4 and 6, the client publishes an authentication MoQ metadata track and the edge relay subscribes to this track so that it gets a watermark identifier, which may be updated at regular intervals.

The method 700 also includes in response to receiving the request, subscribing to one or more video tracks in order to receive units in the one or more video tracks representing the media stream, as represented by block 740. In some embodiments, each of the units represents an object, a subgroup, or a group in the media stream. As such, in comparison to the value position of DASH-IF WMPaceInfo, which is applied at ABR segment level, the watermark signal here can apply at various granularities, such as at the MoQ group level, the subgroup level, or the object level as shown in FIG. 2. The method additionally includes constructing the watermarked video track using the units according to the watermark identifier, as represented by block 750, and sending to the client device the watermarked video track, as represented by block 760.

In some embodiments, announcing the watermarked video track for the media stream includes receiving signaling of the one or more video tracks and announcing the watermarked video track associated with the one or more video tracks. In such embodiments, subscribing to the one or more video tracks includes subscribing to the one or more video tracks associated with the requested watermarked video track in accordance with various embodiments. Further in such embodiments, subscribing to the one or more video tracks includes subscribing to one or more metadata tracks associated with the one of more video tracks; and constructing the watermarked video track using the units according to the watermark identifier includes, obtaining a bit index for each of the units of the one or more video tracks associated with the watermarked video track from the one or more metadata tracks associated with the one or more video tracks, and selecting a respective unit from the units to be included in the watermarked video track according to the watermark identifier and the bit index.

For example, for A/B watermarking shown in FIG. 5, the edge relay 130 receives the message from the publisher 110 via the relay(s) 120, e.g., Catalog (t1a, t1b), signaling A/B variants of the original media stream t1, e.g., video tracks t1a and t1b representing the media stream t1. In response to receiving the message, the edge relay 130 announces the watermarked video track t1 (WM t1) associated with the video tracks t1a and t1b. As such, the edge relay 130 announces half of the video tracks with an A/B neutral track name. In FIG. 6B, the edge relay 130 subscribes to the video tracks t1a and t1b and subscribes to Timeline track(s) associated with the video tracks t1a and t1b. Further as shown in FIG. 6B, the A/B watermarking system 600B explicitly signals the bit index per unit in the out-of-band watermark metadata, e.g., via WMPaceInfo in the Timeline track. Using the out-of-band watermark metadata, in FIG. 6B, the watermark embedder 40 obtains a bit index for each of the units in the video tracks t1a and t1b, selects a unit from either t1a or t1b, and includes the selected unit to the watermarked video track t1 according to the WMID and the bit index.

In some embodiments, constructing the watermarked video track using the units according to the watermark identifier includes deriving a bit index for each of the units, and selecting a respective unit from the units to be included in the watermarked video track according to the watermark identifier and the bit index. For example, in A/B watermarking shown in FIG. 6A, the bit index (e.g., WMPaceInfo) is derived from the metadata attached to the unit, e.g., the unit identifier, a timestamp attached to the unit, etc. The watermark embedder 40 (FIG. 6A) can then use the bit index and the WMID to select a unit from either t1a or t1b, and includes the selected unit to the watermarked video track t1.

In some embodiments, subscribing to the one or more video tracks includes subscribing to a single video track associated with the requested watermarked video track. In such embodiments, subscribing to the single video track includes subscribing to a metadata track associated with the single video track to obtain watermark embedding metadata for each of the units of the single video track; and constructing the watermarked video track according to the watermark identifier includes performing watermark embedding on each of the units using the watermark identifier and the watermark embedding metadata in accordance with various embodiments. Also in such embodiments, constructing the watermarked video track according to the watermark identifier includes performing watermark embedding on each of the units of the single video track using the watermark identifier and watermark embedding instructions received in-band with the units.

For example, in edge watermarking shown in FIGS. 3 and 4A-4B, there is a 1:1 relationship for video tracks in and out of the edge relay 130, e.g., video track t1 announced by the publisher 110 in the catalog message is associated with the watermarked video track t1 announced by the edge relay 130, video track t2 announced by the publisher 110 in the catalog message is associated with the watermarked video track t2 announced by the edge relay 130, and video track t3 announced by the publisher 110 in the catalog message is associated with the watermarked video track t3 announced by the edge relay 130, etc. In other words, the edge relay 130 announces the same video tracks as received from the relay(s) 120 and discards the watermark metadata from the relay(s) 120 (e.g., Timeline message(s)) in accordance with various embodiments. The announcement of the video tracks t1, t2, and t3 in Catalog message(s) by the edge relay 130, e.g., Catalog(t1, t2, t3) as shown in FIG. 3, allows the client device 140 to subscribe to a watermarked video track and allows the edge relay 130 to send SUB(t1) message upstream to subscribe to the single video track t1 associated with the requested watermarked video track t1.

Further, for edge watermarking with out-of-band watermark embedding metadata placed in a dedicated track as shown in FIG. 4B, the edge relay 130 subscribes to a single video track t1 associated with the requested watermarked video track and subscribes to the metadata track associated with the video track t1 in step 2b. Subscribing to the metadata track allows the edge relay 130 to obtain watermark embedding metadata for each units of the units in the video track t1 out-of-band in step 5b. The edge relay 130 then performs watermark embedding on each of the units using the watermark identifier and the watermark embedding metadata in step 6b. On the other hand, for edge watermarking using in-band watermark embedding metadata as shown in FIG. 4A, the watermark metadata including the watermark embedding instructions can be included in the video data (e.g., in the header), and the edge relay 130 (e.g., the watermark embedder 40) applies the watermark instructions it receives in-band from the publisher 110 to the units in the video track t1 and uses the watermark identifier provided by the client device 140 to generate watermark embedded track t1.

In some embodiments, the method 700 further includes receiving a subsequent request for the watermarked video track, and in response to receiving the subsequent request, forgoing subscribing to the one or more video tracks. For example, in FIG. 1, when multiple users at client devices 140-1, 140-2, . . . , 140-N request the same stream, the edge relay 130 subscribes once to the publisher 110 upon receiving a request for the stream from one of the client devices 140 for the first time and stores the request, the watermark metadata, and/or the media content in the cache 50. Upon receiving subsequent requests from other client devices 140 for the same stream, the edge relay 130 forgoes subscribing to the same stream for improved efficiency and reduction of resources.

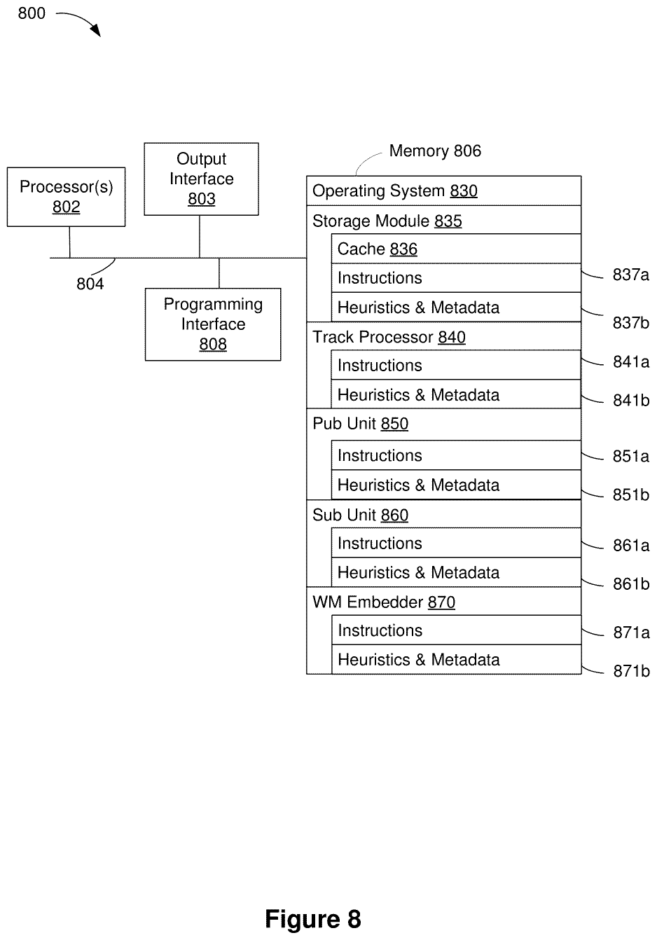

FIG. 8 is a block diagram of a computing device 800 for edge relay watermarking in accordance with some embodiments. In some embodiments, the computing device 800 corresponds to the one or more servers hosting the edge relay 130 (FIGS. 1, 3, 4A-4B, 5, and 6A-6B) and performs one or more of the functionalities described above performed by the edge relay 130. While certain specific features are illustrated, those skilled in the art will appreciate from the present disclosure that various other features have not been illustrated for the sake of brevity, and so as not to obscure more pertinent aspects of the embodiments disclosed herein. To that end, as a non-limiting example, in some embodiments the computing device 800 includes one or more processing units 802 (e.g., CPU(s)/GPU(s)), one or more output interfaces 803 (e.g., one or more network interfaces for connecting with another computing device), a memory 806, a programming interface 808, and one or more communication buses 804 for interconnecting these and various other components.

In some embodiments, the communication buses 804 include circuitry that interconnects and controls communications between system components. The memory 806 includes high-speed random access memory, such as DRAM, SRAM, DDR RAM or other random access solid state memory devices; and, in some embodiments, include non-volatile memory, such as one or more magnetic disk storage devices, optical disk storage devices, flash memory devices, or other non-volatile solid state storage devices. The memory 806 optionally includes one or more storage devices remotely located from the CPU(s) 802. The memory 806 comprises a non-transitory computer readable storage medium. Moreover, in some embodiments, the memory 806 or the non-transitory computer readable storage medium of the memory 806 stores the following programs, modules and data structures, or a subset thereof including an optional operating system 830, a storage module 835, a track processor 840, a publishing unit 850, a subscription unit 860, and a watermark embedder 870. In some embodiments, one or more instructions are included in a combination of logic and non-transitory memory. The operating system 830 includes procedures for handling various basic system services and for performing hardware dependent tasks.

In some embodiments, the storage module 835 is configured to store and/or manage data to facilitate edge relay watermarking. In some embodiments, the storage module 835 includes a cache 836 (e.g., the cache 50, FIGS. 1, 3, 4A-4B, 5, and 6A-6B) for storing media data, requests, and/or metadata for watermarking, etc. To that end, the storage module 835 includes a set of instructions 837a and heuristics and metadata 837b.

In some embodiments, the track processor 840 (e.g., the track processor 10, FIGS. 1, 3, 4A-4B, 5, and 6A-6B) is configured to process the published track information from the publisher and modifies the catalog track to stop the transmission of Timeline metadata tracks and/or to stop advertising the A/B variants to the clients. To that end, the track processor 840 includes a set of instructions 841a and heuristics and metadata 841b.

In some embodiments, the publishing unit 850 (e.g., the publishing unit 20, FIGS. 1, 3, 4A-4B, 5, and 6A-6B) is configured to publish the modified catalog tracks generated by the track processor 840 as watermarked video tracks. To that end, the publishing unit 850 includes a set of instructions 851a and heuristics and metadata 851b.

In some embodiments, the subscription unit 860 (e.g., the subscription unit 30, FIGS. 1, 3, 4A-4B, 5, and 6A-6B) is configured to subscribe to tracks from the publisher in response to receiving requests for the watermarked video tracks published by the publishing unit 850. To that end, the subscription unit 860 includes a set of instructions 861a and heuristics and metadata 861b.

In some embodiments, the watermark embedder 870 (e.g., the watermark embedder 40, FIGS. 1, 3, 4A-4B, 5, and 6A-6B) is configured to embed watermarks. To that end, the watermark embedder 870 includes a set of instructions 871a and heuristics and metadata 871b.

Although the storage module 835, the track processor 840, the publishing unit 850, the subscription unit 860, and the watermark embedder 870 are illustrated as residing on a single computing device 800, it should be understood that in other embodiments, any combination of the storage module 835, the track processor 840, the publishing unit 850, the subscription unit 860, and the watermark embedder 870 can reside in separate computing devices in various embodiments. For example, in some embodiments, each of the storage module 835, the track processor 840, the publishing unit 850, the subscription unit 860, and the watermark embedder 870 resides on a separate computing device.

Moreover, FIG. 8 is intended more as functional description of the various features which are present in a particular implementation as opposed to a structural schematic of the embodiments described herein. As recognized by those of ordinary skill in the art, items shown separately could be combined and some items could be separated. For example, some functional modules shown separately in FIG. 8 could be implemented in a single module and the various functions of single functional blocks could be implemented by one or more functional blocks in various embodiments. The actual number of modules and the division of particular functions and how features are allocated among them will vary from one embodiment to another, and may depend in part on the particular combination of hardware, software and/or firmware chosen for a particular embodiment.

While various aspects of implementations within the scope of the appended claims are described above, it should be apparent that the various features of implementations described above may be embodied in a wide variety of forms and that any specific structure and/or function described above is merely illustrative. Based on the present disclosure one skilled in the art should appreciate that an aspect described herein may be implemented independently of any other aspects and that two or more of these aspects may be combined in various ways. For example, an apparatus may be implemented and/or a method may be practiced using any number of the aspects set forth herein. In addition, such an apparatus may be implemented and/or such a method may be practiced using other structure and/or functionality in addition to or other than one or more of the aspects set forth herein.

It will also be understood that, although the terms “first,” “second,” etc. may be used herein to describe various elements, these elements should not be limited by these terms. These terms are only used to distinguish one element from another. For example, a first device could be termed a second device, and, similarly, a second device could be termed a first device, which changing the meaning of the description, so long as all occurrences of the “first device” are renamed consistently and all occurrences of the “second device” are renamed consistently. The first device and the second device are both devices, but they are not the same device.

The terminology used herein is for the purpose of describing particular embodiments only and is not intended to be limiting of the claims. As used in the description of the embodiments and the appended claims, the singular forms “a”, “an”, and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in accordance with a determination” or “in response to detecting”, that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

1. A method comprising:
at a server including one or more processors and non-transitory memory:
announcing a watermarked video track for a media stream;
obtaining from a client device a watermark identifier associated with a request for the watermarked video track;
in response to receiving the request, subscribing to one or more video tracks in order to receive units in the one or more video tracks representing the media stream;
constructing the watermarked video track using the units according to the watermark identifier; and
sending to the client device the watermarked video track.

2. The method of claim 1, wherein announcing the watermarked video track for the media stream includes:
detecting announcement of a metadata track associated with the one or more video tracks; and
announcing the watermarked video track without announcing the metadata track.

3. The method of claim 1, wherein the request is a subscribe message from the client device to the server and the watermark identifier is included in the subscribe message.

4. The method of claim 1, wherein obtaining from the client device the watermark identifier includes:
detecting an authentication track published by the client device as the request; and
obtaining the watermark identifier by subscribing to the authentication track.

5. The method of claim 1, wherein each of the units represents an object, a subgroup, or a group in the media stream.

6. The method of claim 1, wherein:
announcing the watermarked video track for the media stream includes:
receiving signaling of the one or more video tracks; and
announcing the watermarked video track associated with the one or more video tracks; and
subscribing to the one or more video tracks includes subscribing to the one or more video tracks associated with the requested watermarked video track.

7. The method of claim 6, wherein:
subscribing to the one or more video tracks includes subscribing to one or more metadata tracks associated with the one of more video tracks; and
constructing the watermarked video track using the units according to the watermark identifier includes:
obtaining a bit index for each of the units of the one or more video tracks associated with the watermarked video track from the one or more metadata tracks associated with the one or more video tracks; and
selecting a respective unit from the units to be included in the watermarked video track according to the watermark identifier and the bit index.

8. The method of claim 1, wherein constructing the watermarked video track using the units according to the watermark identifier includes:
deriving a bit index for each of the units; and
selecting a respective unit from the units to be included in the watermarked video track according to the watermark identifier and the bit index.

9. The method of claim 1, wherein subscribing to the one or more video tracks includes subscribing to a single video track associated with the requested watermarked video track.

10. The method of claim 9, wherein:
subscribing to the single video track includes subscribing to a metadata track associated with the single video track to obtain watermark embedding metadata for each of the units of the single video track; and
constructing the watermarked video track according to the watermark identifier includes performing watermark embedding on each of the units using the watermark identifier and the watermark embedding metadata.

11. The method of claim 9, wherein constructing the watermarked video track according to the watermark identifier includes performing watermark embedding on each of the units of the single video track using the watermark identifier and watermark embedding instructions received in-band with the units.

12. The method of claim 1, further comprising:
receiving a subsequent request for the watermarked video track; and
in response to receiving the subsequent request, forgoing subscribing to the one or more video tracks.

13. A non-transitory memory storing one or more programs, which, when executed by one or more servers with one or more processors, cause the one or more servers to:
announce a watermarked video track for a media stream;
obtain from a client device a watermark identifier associated with a request for the watermarked video track;
in response to receiving the request, subscribe to one or more video tracks in order to receive units in the one or more video tracks representing the media stream;
construct the watermarked video track using the units according to the watermark identifier; and
send to the client device the watermarked video track.

14. The non-transitory memory of claim 13, wherein announcing the watermarked video track for the media stream includes:
detecting announcement of a metadata track associated with the one or more video tracks; and
announcing the watermarked video track without announcing the metadata track.

15. The non-transitory memory of claim 13, wherein the request is a subscribe message from the client device to the server and the watermark identifier is included in the subscribe message.

16. The non-transitory memory of claim 13, wherein obtaining from the client device the watermark identifier includes:
detecting an authentication track published by the client device as the request; and
obtaining the watermark identifier by subscribing to the authentication track.

17. The non-transitory memory of claim 13, wherein each of the units represents an object, a subgroup, or a group in the media stream.

18. The method of claim 1, non-transitory memory of claim 13, wherein the one or more programs, which, when executed by the one or more servers, further cause the one or more servers to:
receive a subsequent request for the watermarked video track; and
in response to receiving the subsequent request, forgo subscribing to the one or more video tracks.

19. A server comprising:
one or more processors;
a non-transitory memory;
a network interface; and
one or more programs, stored in the non-transitory memory, which, when executed by the one or more processors, cause the server to:
announce a watermarked video track for a media stream;
obtain from a client device a watermark identifier associated with a request for the watermarked video track;
in response to receiving the request, subscribe to one or more video tracks in order to receive units in the one or more video tracks representing the media stream;
construct the watermarked video track using the units according to the watermark identifier; and
send to the client device the watermarked video track.

20. The server of claim 19, wherein each of the units represents an object, a subgroup, or a group in the media stream.
